(19) United States
(12) Patent Application Publication
(10) Pub. No.: US 2026/0349819 A1
(43) Pub. Date: Nov. 5, 2026

(54) TASK PROCESSING METHOD AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Hui ZOU, Shenzhen (CN); Guangyou YU, Shenzhen (CN); Fanjie MENG, Shenzhen (CN); Yun ZHAO, Shenzhen (CN)

(73) Assignee: TENCENT TECHNOLOGY (SHENZHEN) COMPANY LIMITED, Shenzhen (CN)

(21) Appl. No.: 19/722,062

(22) Filed: Jun. 26, 2026

Related U.S. Application Data
(63) Continuation of application No. PCT/CN2025/090821, filed on Apr. 24, 2025.

(30) Foreign Application Priority Data
Apr. 26, 2024 (CN) 202410518047.0

(51) Int. Cl. G06F 9/50

(52) U.S. Cl. CPC G06F 9/5027

(57) ABSTRACT

A task processing method includes determining at least one pod, each pod of the at least one pod being configured to process at least one data processing task, obtaining a resource demand amount of each pod within a preset time period, determining a remaining allocatable resource amount of each task processing node in a task processing node cluster within the preset time period, the task processing node cluster comprising at least two task processing nodes, and determining, based on the resource demand amount of each pod and the remaining allocatable resource amount of each task processing node, a target node associated with a corresponding pod from the at least two task processing nodes to run the corresponding pod in the target node.

### CROSS-REFERENCE TO RELATED APPLICATIONS

This application is a continuation application of International Application No. PCT/CN2025/090821 filed on Apr. 24, 2025, which claims priority to Chinese Patent Application No. 202410518047.0, filed with the China National Intellectual Property Administration on Apr. 26, 2024, the disclosures of each being incorporated by reference herein in their entireties.

### FIELD

The disclosure relates to the field of computer technologies, for example, may relate to the field of cloud technologies, database processing, and the like. Specifically, the disclosure relates to a task processing method and apparatus, an electronic device, a storage medium, and a program product.

### BACKGROUND

A container cluster management system (for example, Kubernetes, K8s) is a container-based cluster management platform. A plurality of nodes and a plurality of pods are deployed in a cluster managed by K8s. When executing a data processing task, a pod can carry a to-be-processed data task and be scheduled to a corresponding node to run the task. Therefore, how to determine a corresponding node from the plurality of nodes for a to-be-scheduled pod becomes a key problem.

In the related art, a Kube-Scheduler is used to determine the corresponding node from the plurality of nodes for a to-be-scheduled pod. Specifically, the Kube-Scheduler is an official scheduler provided by Kubernetes, and is configured to process a scheduling request of a pod. The Kube-Scheduler makes a scheduling decision by comparing a resource demand statically declared by the pod with a total resource specification of each node. When a total quantity of resources declared by the to-be-scheduled pod and resources declared by a scheduled pod on the node is less than the total resource specification of the node, the pod can be scheduled to the node.

However, in the foregoing technology, the pod can be scheduled only according to a resource request, to execute the to-be-processed data task on the corresponding node, which may result in low accuracy in determining a to-be-scheduled node for the pod, and may further lead to a series of load imbalance issues. For example, for some nodes, an actual load is close to the requested resources, which may result in a high probability of stability issues. For other nodes, an actual node load is far less than the requested resources, which may result in resource waste.

### SUMMARY

One or more embodiments provide a task processing method, performed by an electronic device, including: determining at least one pod, each pod of the at least one pod being configured to process at least one data processing task; obtaining a resource demand amount of each pod within a preset time period; determining a remaining allocatable resource amount of each task processing node in a task processing node cluster within the preset time period, the task processing node cluster comprising at least two task processing nodes; and determining, based on the resource demand amount of each pod and the remaining allocatable resource amount of each task processing node, a target node associated with a corresponding pod from the at least two task processing nodes to run the corresponding pod in the target node.

One or more embodiments provide a task processing apparatus including: at least one memory configured to store program code; and at least one processor configured to read the program code and operate as instructed by the program code, the program code comprising: first determining code configured to cause at least one of the at least one processor to determine at least one pod, each pod of the at least one pod being configured to process at least one data processing task; first obtaining code configured to cause at least one of the at least one processor to obtain a resource demand amount of each pod within a preset time period; second determining code configured to cause at least one of the at least one processor to determine a remaining allocatable resource amount of each task processing node in a task processing node cluster within the preset time period, the task processing node cluster comprising at least two task processing nodes; and third determining code configured to cause at least one of the at least one processor to determine, based on the resource demand amount of each pod and the remaining allocatable resource amount of each task processing node, a target node associated with a corresponding pod from the at least two task processing nodes, to run the corresponding pod in the target node.

One or more embodiments provide a non-transitory computer-readable storage medium, storing computer code which, when executed by at least one processor, causes the at least one processor to at least: determine at least one pod, each pod of the at least one pod being configured to process at least one data processing task; obtain a resource demand amount of each pod within a preset time period; determine a remaining allocatable resource amount of each task processing node in a task processing node cluster within the preset time period, the task processing node cluster comprising at least two task processing nodes; and determine, based on the resource demand amount of each pod and the remaining allocatable resource amount of each task processing node, a target node associated with a corresponding pod from the at least two task processing nodes to run the corresponding pod in the target node.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1A is a schematic diagram of an application environment of a task processing method according to one or more embodiments.

FIG. 1B is a schematic architectural diagram of a Kubernetes system according to one or more embodiments.

FIG. 1C is a schematic diagram of another application environment of a task processing method according to one or more embodiments.

FIG. 2 is a schematic flowchart of a task processing method according to one or more embodiments.

FIG. 3 is a flowchart of an example of a task processing method according to one or more embodiments.

FIG. 4 is a flowchart of another example of a task processing method according to one or more embodiments.

FIG. 5 is a schematic structural diagram of a task processing apparatus according to one or more embodiments.

FIG. 6 is a schematic structural diagram of an apparatus of an electronic device according to one or more embodiments.

### DETAILED DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

A person skilled in the art may understand that, the singular forms “a”, “an”, “the” and “this” used herein may include the plural forms as well, unless the context clearly indicates otherwise. Further, the terms “include” and “comprise” used in some embodiments indicate that the corresponding features may be implemented as the disclosed features, information, data, steps, operations, elements, and/or components, but do not exclude implementation as other features, information, data, steps, operations, elements, components, and/or a combination thereof supported in the art. When an element is referred to as being “connected” or “coupled” to another element, the element may be directly connected or coupled to the another element, or it may indicate that a connection relationship is established between the element and the another element through an intermediate element. In addition, the “connection” or “coupling” used herein may include wireless connection or wireless coupling.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.” When a plurality of (two or more) items are described, if a relationship among the plurality of items is not clearly defined, the plurality of items may refer to one, more, or all of the plurality of items. For example, the description “parameter A includes A1, A2, and A3” may be implemented as that parameter A includes A1, A2, or A3, or may be implemented as that parameter A includes at least two of A1, A2, and A3.

To better understand the embodiments provided in the disclosure, some terms are described as follows.

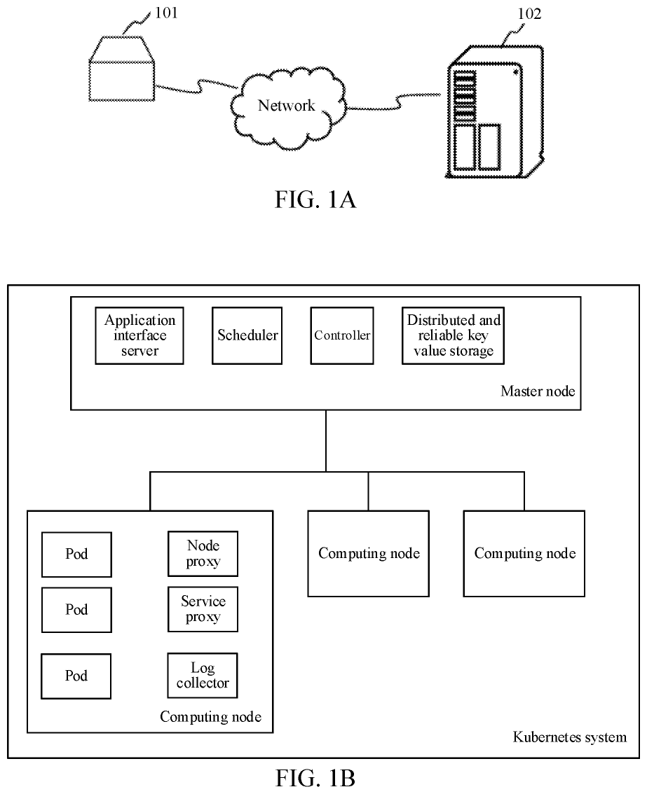

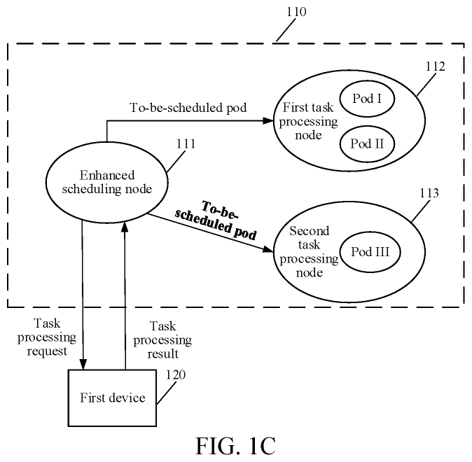

Kubernetes: It is an open-source platform for managing containerized applications on a plurality of hosts in a cloud platform. An objective of Kubernetes is to simplify and enhance deployment of the containerized applications. Kubernetes provides a mechanism for application deployment, planning, update, and maintenance. Kubernetes defines a series of construction modules on a design structure, with an objective to provide a mechanism that may jointly provide deployment, maintenance, and extension of applications. Components forming Kubernetes are designed to be loosely coupled and extensible, allowing them to satisfy a wide variety of workloads. Extensibility is provided by a Kubernetes API to a large extent. The API is mainly used as an internal component for extensions and a container running on Kubernetes. Referring to FIG. 1A, FIG. 1A is a schematic architectural diagram of a Kubernetes system according to one or more embodiments. As shown in FIG. 1B, a Kubernetes system generally includes a master node (Master) and a plurality of computing nodes (Nodes). The Master shown herein may be an enhanced scheduling node shown below. The Master node includes an API Server, a Scheduler, a Controller manager, and etcd. The API Server is an external interface of the entire system, allowing a client and other components to invoke. The Scheduler is responsible for scheduling resources inside a cluster. The Controller manager is a controller responsible for management, etcd is a distributed and reliable key-value storage for storing data. The Node includes pods, Docker, kubelet, kube-proxy, and Fluentd. The pod is the most basic operational unit in Kubernetes. A pod represents a process running in the cluster, and one or more closely related containers are encapsulated in the pod. Docker is configured to create a container. kubelet is responsible for detecting pods assigned to its Node, including creation, modification, deletion, and the like. kube-proxy is responsible for providing a proxy for a pod object. Fluentd is responsible for log collection, storage, and querying.

Pod: A basic scheduling unit in Kubernetes is referred to as a “pod”. Through this type of abstraction, higher-level abstract content may be added to a containerized component. A pod generally includes one or more containers, ensuring that the containers are always located on a host and may share resources. Each pod in Kubernetes is assigned a unique (cluster-wide) IP address, allowing applications to use the same port without causing conflicts. The pod may define a volume, such as a local disk directory or a network disk, and expose the volume to one of the containers in the pod. The pod may be manually managed through the Kubernetes API, or may be delegated to a controller for automatic management.

Node: It is also referred to as Worker, Minion, or Node, and is a single machine (or virtual machine) for deploying containers (workloads). Each node in the cluster needs to have a running environment (runtime) of the container, such as Docker.

Application programming interface server (API Server): It provides a resource representational state transfer (HTTP Rest) interface for adding, deleting, modifying, searching, and obtaining various Kubernetes resource objects, and is a data bus and a data center of the entire system. Functions of the API Server: (1) Providing application programming interfaces (RestAPIs) for cluster management (including authentication and authorization, data verification, and cluster state change); (2) Providing a hub for data interaction and communication among other modules (other modules query or modify data through the API Server); (3) Serving as an entry for resource quota control; and (4) Providing a comprehensive cluster security mechanism.

Cosine similarity: It is a method for measuring a similarity between two vectors. It determines the similarity between two vectors by calculating a cosine value of an angle between the two vectors. A value of the cosine similarity ranges from −1 to 1, and when directions of the two vectors are completely the same, the cosine similarity is 1; when the directions of the two vectors are completely opposite, the cosine similarity is −1; and when the directions of the two vectors are completely unrelated, the cosine similarity is 0. In the fields of natural language processing, recommendation systems, and the like, the cosine similarity is often configured for measuring a similarity between texts, users, or items. For example, in text mining, each document may be represented as a vector in a high-dimensional space, where each dimension of the vector corresponds to a term, and a value of the dimension represents a weight of the term in the document. By calculating a cosine similarity between vectors of two documents, their content similarity may be obtained.

Euclidean distance: It is a method for measuring a distance between two points, and is the most commonly used distance metric in Euclidean space. The Euclidean distance is obtained by calculating a straight-line distance between two points, and its calculation formula is based on the Pythagorean theorem.

A Euclidean distance between two points A (x1, y1) and B (x2, y2) on a two-dimensional plane may be calculated by using the following formula:

distance=sqrt((x2−x1)\hat{ }2+(y2−y1)\hat{ }2);

In a high-dimensional space, a Euclidean distance between two points may be calculated by using a similar formula: simply sum the squared differences in each dimension and then take the square root.

The Euclidean distance is widely used in many fields, such as data mining, machine learning, and image processing. In these fields, the Euclidean distance is often configured for measuring a similarity or dissimilarity between samples.

Component: It is a functional module of a view of a mini program, and is also referred to as a front-end component, including a button, a title, a heading, a sidebar, content, a footer, and the like on a page. The Component includes modular code, to be repeatedly used in different pages of the mini program.

Workload: A workload is a type of application, and may include a plurality of replica instances.

In the related art, there is also a method for scheduling a pod according to a current real utilization of a node, but the pod is not scheduled according to an actual resource demand of the pod. The following scenario may occur: an actual resource demand of a pod at time t plus a real resource utilization of a node at time t exceeds a total resource of the node multiplied by a target scheduling threshold (t is any time). When the foregoing scenario is encountered, the pod may still be scheduled to the node. After the scheduling, insufficient available resources on the node may be caused, resulting in stability issues.

A container includes a running environment of at least one application. In some embodiments, the container is a running environment that encapsulates an application and all its dependencies (a runtime environment, a system tool, a library, and the like).

One or more embodiments provide a method for staggered deployment based on an actual resource demand, so that services of the same scale can be supported by using fewer resource specifications, or resource contention can be reduced while a total resource specification is unchanged, thereby improving scheduling reliability. Some embodiments may be applied to a Kubernetes cluster, but is not limited to the Kubernetes cluster.

In some embodiments, the solution may relate to a cloud technology and a database processing technology. For example, the solution in some embodiments may be performed by a server. The server may be a cloud server. Data processing involved in an implementation process of the solution may be implemented based on the cloud technology, and data storage involved in the implementation process may use cloud storage. For example, calculation of a Euclidean distance between a resource demand amount corresponding to each to-be-scheduled pod and a remaining allocatable resource amount corresponding to each task processing node may be implemented by using a cloud technology, and a resource demand amount corresponding to each pod may be stored in cloud storage on a cloud server.

For example, a database may be simply viewed as an electronic file cabinet, which is a place for storing electronic files, and a user may perform operations such as adding, querying, updating, and deleting data in the files. The so-called “database” is a set of data stored together in a certain manner, sharable among a plurality of users, with minimal redundancy, and independent of applications. A database management system (DBMS) is a computer software system designed for managing the database, and generally has basic functions such as storage, interception, security guarantee, and backup. Database management systems may be classified based on supported database models, such as relational models or extensible markup language (XML); based on supported computer types, such as server clusters or mobile phones; based on used query languages, such as SQL (Structured Query Language) or XQuery; based on performance priorities, such as maximum scale or peak operating speed; or based on other classification manners. Regardless of the classification manner, some DBMSs can span categories, for example, may support a plurality of query languages simultaneously.

Cloud computing is a computing mode, in which computing tasks are distributed on a resource pool formed by a large quantity of computers, so that various application systems can obtain computing power, storage capacity, and information services according to requirements. A network that provides resources is referred to as a “cloud”. For a user, the resources in the “cloud” seem to be infinitely expandable, and can be obtained readily, used on demand, expanded readily, and billed based on usage.

A basic capability provider of cloud computing (that is, a cloud manufacturer) establishes a cloud computing resource pool (cloud platform for short, and generally referred to as an infrastructure as a service (IaaS) platform), in which a plurality of types of virtual resources are deployed for selection and use by external customers. The cloud computing resource pool mainly includes: a computing device (which is a virtualized machine including an operating system), a storage device, and a network device.

According to functional logic, a platform as a service (PaaS) layer may be deployed on an infrastructure as a service (IaaS) layer, and then a software as a service (SaaS) layer is deployed on the PaaS layer, or the SaaS layer may be directly deployed on the IaaS layer. PaaS is a platform for running software, such as a database and a web container. SaaS is various service software, such as a web portal and a bulk messaging system. Generally, SaaS and PaaS are upper layers relative to IaaS.

The cloud technology is a collective term of a network technology, an information technology, an integration technology, a management platform technology, an application technology, and the like implemented based on a cloud computing business mode. These technologies may form a resource pool, which is used on demand, and is flexible and convenient. The cloud computing technology becomes an important support. Cloud storage is a new concept that extends and develops from the cloud computing concept. A distributed cloud storage system (storage system for short below) refers to a storage system that uses functions such as a cluster application, a grid technology, and a distributed storage file system to integrate a large quantity of storage devices (which are also referred to as storage nodes) of different types in a network through application software or an application interface for collaborative work, and jointly provides data storage and service access functions to the outside.

A cloud product refers to a cloud computing product providing cloud services. Cloud computing products are diverse and widely used in various fields such as transportation, healthcare, and energy. Different products have different features and application scenarios. For example, a cloud management product is configured to manage and deploy cloud computing resources, to perform uniform management on the cloud resources; a cloud storage product provides storage services based on a cloud computing platform, and can provide massive storage capacity and an efficient access speed; a cloud security product relates to protecting network security of a cloud computing environment, and provides a strong safeguarding function; and a cloud communication product provides communication services based on the cloud computing platform, to implement data transmission, and provides a more convenient and efficient communication manner.

In some embodiments, relevant data, for example, involved object information (a to-be-processed task, or the like) requires obtaining the consent or authorization of the objects when one or more embodiments are applied to a specific product or technology, and the collection, use, and processing of relevant data needs to comply with relevant laws, regulations, and standards of relevant countries and regions. In other words, in some embodiments, if data related to the objects is involved, the data needs to be obtained with the authorization and consent of the objects, authorization and consent of relevant departments, and in compliance with the relevant laws, regulations and standards of the countries and regions. If personal information is involved in the embodiments, the obtaining of all personal information needs to require consent of individuals. If sensitive information is involved, separate consent of information subjects needs to be obtained. The embodiments also need to be implemented with the authorization and consent of the objects.

An objective of one or more embodiments is to provide a task processing method and apparatus, an electronic device, a storage medium, and a program product, to reduce load imbalance issues that may occur when a corresponding node is determined for a to-be-scheduled pod to execute a to-be-processed task. To achieve the above objective, technical solutions provided by one or more embodiments are as follows.

One or more embodiments provides an application environment of a task processing method. Referring to FIG. 1A, the application environment includes: a first device 101 and a second device 102. The first device 101 and the second device 102 are connected through a network. The first device 101 is an access device, and the second device 102 is an accessed device. The first device 101 is a device in which a data processing task initiator is located; and may be an application server of an application, or a terminal, an in-vehicle device, a smart speaker, or the like in which a client of the application is located. This is not specifically limited herein. The second device 102 may be a master node in a cluster system. The server may be an independent physical server, or may be a server cluster or a distributed system including a plurality of physical servers, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The cluster system is, for example, a Kubernetes system in FIG. 1B. A node may be a device without a public network IP, such as a smart car, a smart speaker, or a smartwatch, but is not limited thereto. The node and the server may be directly or indirectly connected in a wired or wireless communication manner. This is not limited herein.

As an example, based on FIG. 1A, a more detailed scenario is shown in FIG. 1C. The master node is deployed in a cluster system shown in FIG. 1B. FIG. 1C is a schematic diagram of an application scenario of this application according to one or more embodiments. As shown in FIG. 1C, this application scenario includes a cluster system 110 and a first device 120. The cluster system 110 includes an enhanced scheduling node 111 (which may be the master node shown above) and a plurality of task processing nodes (a first task processing node 112 and a second task processing node 113 are exemplarily shown in FIG. 1C). A graphics processing unit (GPU) and/or a central processing unit (CPU) are deployed on each task processing node, and one or more pods may be run on each GPU and/or each CPU. The enhanced scheduling node 111 is configured to perform resource scheduling. Specifically, it may schedule the pods to run in the GPU and/or the CPU in the corresponding task processing node according to the method of some embodiments.

The first device 120 refers to a device in which a data processing task initiator is located; and may be an application server of an application, or a terminal, an in-vehicle device, a smart speaker, and the like in which a client of the application is located. This is not specifically limited herein. A data processing task initiated by the first device 120 may be a face recognition task, an image classification task, a text classification task, a speech recognition task, an audio encoding task, a video decoding task, or the like. This is not specifically limited herein. The GPU (CPU) shown below represents a GPU and/or a CPU, and details are not described in the following embodiments.

The enhanced scheduling node 111 (which may also be referred to as a master node) in the cluster system 110 may further be responsible for communicating with an external device. After receiving a task processing request initiated by the first device 120, the enhanced scheduling node 111 allocates an available GPU (CPU) for the task processing request according to a resource demand amount applied for by the task processing request and a remaining resource amount of the GPU (CPU) in each task processing node, and then may request to create a pod for the data processing task indicated by the task processing request. Then, the enhanced scheduling node 111 may perform pod scheduling according to the method of some embodiments, to schedule a to-be-scheduled pod to run in the GPU (CPU) of the task processing node, to perform task processing by using resources in the GPU (CPU). FIG. 1C exemplarily shows a pod I and a pod II running in a GPU of a first task processing node 112, and a pod III running in a GPU of the second task processing node 113. After the pod ends running, the task processing node may return a task processing result to the enhanced scheduling node 111, and the enhanced scheduling node 111 transmits the task processing result to the first device 120.

If the cluster system 110 is a Kubernetes cluster, the pod may be referred to as a pod. In addition, although the resources are described above by using a GPU and/or a CPU as an example, the resources shown in some embodiments are not limited to the GPU and/or the CPU, and any resources required for running a pod to execute a corresponding data processing task fall within the protection scope of the disclosure.

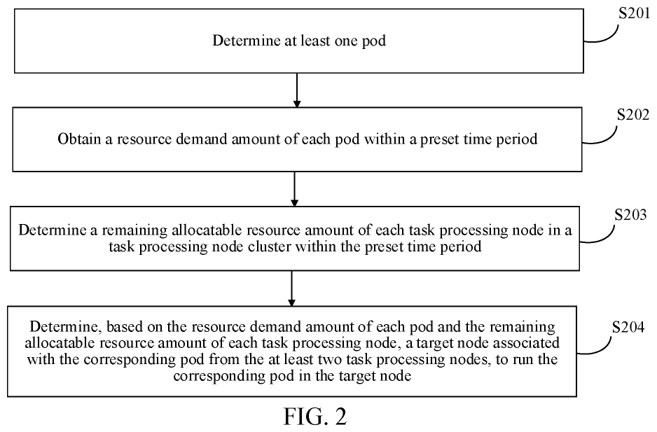

To better understand and describe the method provided in some embodiments, one or more embodiments is first described below with reference to a specific scenario embodiment. Under the foregoing system architecture, one or more embodiments provides a task processing method. The method may be performed by the enhanced scheduling node shown above. In some embodiments, the enhanced scheduling node may be a virtual node deployed in a server, or may be a physical node. As shown in FIG. 2, the method may include the following operations.
Operation S201: Determine at least one pod. Each pod is configured to process at least one data processing task. Each pod includes at least one container.

In some embodiments, for a Kubernetes cluster, a pod may be referred to as a pod. A pod includes an application container (a plurality of containers in some cases), storage resources, a unique network IP address, and some options for determining how the container runs. The pod represents an independent application running instance in Kubernetes, and the instance may include a single container or several tightly coupled containers. In some embodiments, each pod is configured to process at least one data processing task, that is, a pod may carry at least one data processing task, to run the at least one data processing task.

In some embodiments, the data processing tasks may include: a training task, a computing task, a data query task, and the like. Any task that can be executed on a node falls within the protection scope of the disclosure.
Operation 202: Obtain a resource demand amount of each pod within a preset time period.

In some embodiments, the preset time period may be preset, that is, it may be preset by an administrator, or may be determined according to an input of the administrator. In some embodiments, the preset time period may be any time period. For example, one day may be used as the preset time period, or one month may be used as the preset time period.

Specifically, if the preset time period is one day, that is, for each to-be-scheduled pod, a resource demand amount corresponding to the to-be-scheduled pod within one day is obtained.

In some embodiments, the resource demand amount of a pod within the preset time period is predicted based on historical resource usage of the pod. In other words, the resource demand amount of a pod within the preset time period (within the day) is predicted based on the historical resource usage of the pod. The historical resource usage of each pod is resource usage of the corresponding pod in a runtime period. For example, the resource demand amount is an average of quantities of resources used in a plurality of runtime periods. For another example, a preset time period includes at least two unit time periods, and the resource demand amount of each pod includes a resource demand amount of the corresponding pod in each unit time period within the preset time period. The resource demand amount in each unit time period is an average of quantities of resources used in the corresponding unit time period in the plurality of runtime periods, but is not limited thereto.

In some embodiments, the resource demand amount of each pod within the preset time period may be prestored in a database. When a pod needs to be scheduled, the resource demand amount of the pod within the preset time period is obtained from the database. In some embodiments, the resource demand amount of a pod within the preset time period may be predicted based on historical resource usage of the pod.

In some embodiments, with the method, historical resource usage of each pod may further be obtained. The historical resource usage of each pod is the resource usage of the corresponding pod in the runtime period. Then, a resource demand amount of each pod is predicted based on the historical resource usage of each pod. Subsequently, the resource demand amount of each pod is stored.

The resource demand amount of the pod within the preset time period may be predicted by the enhanced scheduling node shown above, or may be predicted by other devices, for example, a prediction component deployed in another device.
Operation 203: Determine a remaining allocatable resource amount of each task processing node in a task processing node cluster within the preset time period.

The task processing node cluster includes at least two task processing nodes, and the remaining allocatable resource amount is a remaining allocatable resource amount of each task processing node in the task processing node cluster within the preset time period. For example, a task processing node 1 and a task processing node 2 may be deployed in the task processing node cluster, that is, a remaining allocatable resource amount of the task processing node 1 within one day (within the day) and a remaining allocatable resource amount of the task processing node 2 within the day are calculated.
Operation S201 and operation S202 may be performed before operation S203, after operation S203, or simultaneously with operation S203 This is not limited in herein.
Operation S204: Determine, based on the resource demand amount of each pod and the remaining allocatable resource amount of each task processing node, a target node associated with the corresponding pod from the at least two task processing nodes, to run the corresponding pod in the target node.

Using an example in which the preset time period is one day, in operation S204, the target node associated with the corresponding pod may be determined from the at least two task processing nodes based on a predicted resource demand amount corresponding to the pod within the day and the remaining allocatable resource amount of each task processing node within the day. In some embodiments, in operation S204, a node for optimal compact packing is selected as a target node for the corresponding pod to optimize a scheduling decision.

Further, after the target node is determined for a pod, the target node is used as a task processing node finally bound to the pod, to run the corresponding pod in the target node, to execute at least one data processing task associated with the corresponding pod.

Compared with the related art, in some embodiments, for a to-be-scheduled pod, when a task processing node for scheduling the pod is determined from a plurality of task processing nodes in a task processing node cluster, a target task processing node is determined based on a resource demand amount of the to-be-scheduled pod within a preset time period and a relationship among remaining allocatable resource amounts corresponding to the task processing nodes within the preset time period, to schedule the pod to execute a corresponding task, thereby improving accuracy of node allocation for the to-be-scheduled pod, and further minimizing the occurrence of load imbalance. In addition, because the resource demand amount of the to-be-scheduled pod within the preset time period is obtained based on historical resource usage of the pod, accuracy of the resource demand amount of the to-be-scheduled pod within the preset time period is higher, so that accuracy of the node allocation for the to-be-scheduled pod can be further improved, thereby further improving load balance.

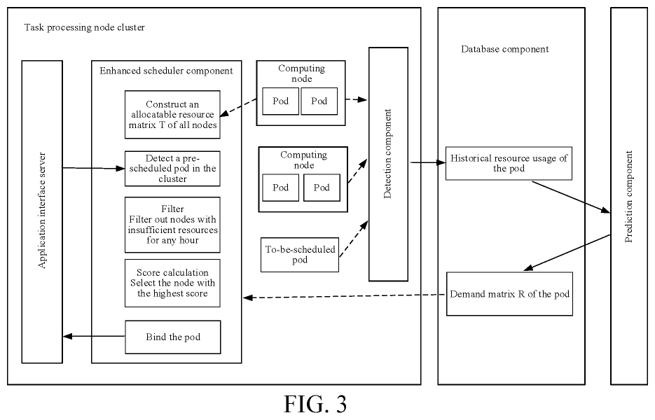

In one or more embodiments, as shown in FIG. 3, for a Kubernetes cluster, an enhanced scheduler component may be deployed in the cluster. The enhanced scheduler component may be deployed in the enhanced scheduling node shown above. An API Server is further deployed in the cluster, that is, the enhanced scheduler component may detect a creation event of a pod object (pod) without a nodename from the API Server, and a scheduler component specified by the creation event of the pod object is the enhanced scheduler component, to determine the pod object without a nodename as a to-be-scheduled pod (specifically, the to-be-scheduled pod may be detected by using the API Server). In some embodiments, a manner for creating a new pod and specifying the scheduler component as the enhanced scheduler component is as follows.
template:
   metadata:
      labels:
         app: my-app
   spec:
      schedulerName: this-scheduler

Further, in some embodiments, as shown in FIG. 3, for the Kubernetes cluster, a detection component may be deployed in the cluster. The detection component may be located in the enhanced scheduling node shown above, or may not be deployed in the enhanced scheduling node shown above. Further, in some embodiments, a database component and a prediction component may further be deployed. The database component and the prediction component may be located in the Kubernetes cluster, or may not be located in the Kubernetes cluster. As shown in FIG. 3, the database component and the prediction component are not located in the Kubernetes cluster. The detection component may periodically collect resource usage data corresponding to each pod in the cluster, and store the collected resource usage data corresponding to each pod into the database component. The prediction component may obtain, from the database component, historical resource usage data corresponding to each pod, to predict a resource demand amount corresponding to each pod within the preset time period, and store the resource demand amount into the database component. Subsequently, after the enhanced scheduler component determines a to-be-scheduled pod, the enhanced scheduler component obtains a resource demand amount corresponding to each to-be-scheduled pod within the preset time period from the database component. As shown in FIG. 3, the prediction component periodically obtains the historical resource usage data of each pod, predicts a demand matrix of each pod, and stores the demand matrix into the database component.

Further, when the prediction component is deployed in the Kubernetes cluster, the prediction component and the enhanced scheduler component may be deployed in a device, that is, deployed in the enhanced scheduling node shown above, so that the enhanced scheduling node periodically obtains the historical resource usage corresponding to each pod. The pods include a to-be-scheduled pod and each pod running on each task processing node, and historical resource usage corresponding to any pod is resource usage occupied when the pod runs a historical data processing task. The resource demand amount corresponding to each pod is predicted based on the historical resource usage corresponding to each pod. Then, the resource demand amount corresponding to each pod is stored. In some embodiments, the database component stores the resource demand amount corresponding to each pod.

In some embodiments, the preset time period includes at least two unit time periods, each unit time period having a duration of a preset time unit, the resource demand amount of each pod includes a resource demand amount of the corresponding pod in each unit time period within the preset time period, and the remaining allocatable resource amount of each task processing node includes a remaining allocatable resource amount of the corresponding task processing node in each unit time period within the preset time period. For example, if the preset time period is one day, and the preset time unit is one hour, the resource demand amount of a pod includes the resource demand amount of the pod for each hour within the day.

In some embodiments, the determining a remaining allocatable resource amount of each task processing node in a task processing node cluster within the preset time period may include: obtaining a resource demand amount of each pod running on each task processing node within the preset time period; determining an allocated resource amount of the corresponding task processing node based on the resource demand amount of each pod running on each task processing node within the preset time period; obtaining an initial allocatable resource of each task processing node, the initial allocatable resource of each task processing node being an allocatable resource amount of the corresponding task processing node when no pod is running; and determining the remaining allocatable resource of each task processing node within the preset time period based on the initial allocatable resource of each task processing node and the allocated resource amount of each task processing node.

In some embodiments, each task processing node may already run at least one pod. Therefore, for any task processing node, when the remaining allocatable resource amount of the task processing node within the preset time period is determined, a resource demand amount of each pod running in the task processing node (that is, a resource demand of each pod determined to run within the preset time period) is obtained. Then aggregation is performed based on the resource demand amount of each pod, to obtain an allocated resource amount of the task processing node, and then the remaining allocatable resource amount of the task processing node is determined based on an initial allocatable resource amount of the task processing node and the allocated resource amount of the task processing node. In some embodiments, the initial allocatable resource amount of the task processing node may be first obtained, and then the resource demand amount of each pod running in the task processing node is obtained. In some embodiments, the resource demand amount of each pod running in the task processing node may be first obtained, and then the initial allocatable resource amount of the task processing node is obtained. In some embodiments, the resource demand amount of each pod running in the task processing node and the initial allocatable resource amount of the task processing node may be simultaneously obtained. This is not limited in herein.

The preset time period includes at least two unit time periods, that is, the resource demand amount corresponding to each pod running in the task processing node, the initial allocatable resource of the task processing node, the allocated resource amount of the task processing node, and the remaining allocatable resource amount of the task processing node may all include a remaining allocatable resource amount in each unit time period within the preset time period. In other words, the resource demand amount of each pod running in the task processing node includes a resource demand amount in each unit time period within the preset time period; the initial allocatable resource amount of the task processing node may include: an initial allocatable resource amount in each unit time period within the preset time period; the allocated resource amount of the task processing node may include: an allocated resource amount of the task processing node in each unit time period within the preset time period; and the remaining allocatable resource amount corresponding to the task processing node includes: a remaining allocatable resource amount corresponding to the task processing node in each unit time period within the preset time period.

Using an example in which the preset time period is one day, and the unit time period is one hour, the resource demand amount corresponding to each pod running in the task processing node includes a resource demand amount corresponding to each hour from 0:00 to 24:00 within the day; the initial allocatable resource amount of the task processing node may include an initial allocatable resource amount corresponding to the task processing node for each hour from 0:00 to 24:00 within the day; the allocated resource amount corresponding to the task processing node may include an allocated resource amount corresponding to the task processing node for each hour from 0:00 to 24:00 within the day; and the remaining allocatable resource amount of the task processing node includes a remaining allocatable resource amount corresponding to the task processing node for each hour from 0:00 to 24:00 within the day.

Further, after the allocatable resource amount corresponding to each task processing node in each unit time period within the preset time period is obtained, the determining, based on the resource demand amount of each pod and the remaining allocatable resource amount of each task processing node, a target node associated with the corresponding pod from the at least two task processing nodes, to run the corresponding pod in the target node in operation S204 may specifically include: selecting at least one candidate node meeting the resource demand amount of the corresponding pod from the at least two task processing nodes based on the remaining allocatable resource amount of each task processing node; and determining the target node associated with the corresponding pod from the at least one candidate node based on the resource demand amount of the corresponding pod and a remaining allocatable resource amount of each of the at least one candidate node.

In some embodiments, the resource demand amount of the to-be-scheduled pod and the remaining allocatable resource amount corresponding to each task processing node each are a resource amount in each unit time period within the preset time period. In other words, a predicted resource demand amount corresponding to the to-be-scheduled pod is a resource demand amount corresponding to each unit time period within the preset time period, and the remaining allocatable resource amount of any task processing node is a remaining allocatable resource amount of the task processing node in each unit time period within the preset time period. The resource demand amount in each unit time period is matched with the remaining allocatable resource amount in the corresponding unit time period, to determine the target node, so that accuracy of the target node is high. Further, staggered deployment of services may be performed based on an actual resource demand, thereby maximizing resource utilization, and reducing resource contention.

In some embodiments, the remaining allocatable resource amount corresponding to each task processing node and the resource demand amount of the corresponding pod may be obtained through the foregoing embodiments, to select at least one task processing node whose remaining allocatable resource amount is not less than the resource demand amount corresponding to the to-be-scheduled pod from the task processing nodes as a candidate node.

Specifically, the preset time period includes at least two unit time periods, each unit time period having a duration of a preset time unit, the resource demand amount of each pod includes a resource demand amount of the corresponding pod in each unit time period within the preset time period, and the remaining allocatable resource amount of each task processing node includes a remaining allocatable resource amount of the corresponding task processing node in each unit time period within the preset time period. In some embodiments, the selecting at least one candidate node meeting the resource demand amount of the corresponding pod from the at least two task processing nodes based on the remaining allocatable resource amount of each task processing node may include: selecting at least one candidate node from the at least two task processing nodes based on the remaining allocatable resource amount of each task processing node in each unit time period and the resource demand amount of the corresponding pod in each unit time period. For each unit time period, the remaining allocatable resource amount of each candidate node in the unit time period is greater than the resource demand amount of the corresponding pod in the corresponding unit time period.

As shown in FIG. 3, a unit time period is one hour, and the enhanced scheduler component filters out nodes with insufficient resources for any hour. For example, the remaining allocatable resource amount of each task processing node in each unit time period is a remaining allocatable resource amount corresponding to the task processing node for each hour from 0:00 to 24:00, and a resource demand amount corresponding to the to-be-scheduled pod in each unit time period is a resource demand amount corresponding to the to-be-scheduled pod for each hour of the day. For a task processing node, a remaining allocatable resource amount corresponding to the task processing node for each hour from 0:00 to 24:00 is compared, hour by hour, with a resource demand amount corresponding to the to-be-scheduled pod for each hour from 0:00 to 24:00, to select the hours in which the remaining allocatable resource amount is not less than the corresponding resource demand amount, that is, the remaining allocatable resource amount corresponding to the hour from 0:00 to 1:00 is not less than the resource demand amount corresponding to the hour from 0:00 to 1:00, the remaining allocatable resource amount corresponding to the hour from 1:00 to 2:00 is not less than the resource demand amount corresponding to the hour from 1:00 to 2:00, . . . , and the remaining allocatable resource amount corresponding to the hour from 23:00 to 24:00 is not less than the resource demand amount corresponding to the hour from 23:00 to 24:00.

Further, through the foregoing embodiments, some task processing nodes are first filtered out, and a remaining allocatable resource amount in the task processing nodes at a time may be less than a resource demand amount at this time, to obtain a candidate node in which each remaining allocatable resource amount in each unit time period is greater than a resource demand amount corresponding to the unit time period, thereby improving accuracy of subsequent selection of the target node and reducing a computational amount of the subsequent selection of the target node.

In some embodiments, the determining, based on the resource demand amount of each pod and the remaining allocatable resource amount of each task processing node, a target node associated with the corresponding pod from the at least two task processing nodes, to run the corresponding pod in the target node in operation S204 may specifically include: determining a resource matching degree between each task processing node and the corresponding pod based on the resource demand amount of the corresponding pod and the remaining allocatable resource amount of each task processing node; and determining the target node associated with the corresponding pod from the at least two task processing nodes based on the resource matching degree.

In some embodiments, the determining a resource matching degree between each task processing node and the corresponding pod based on the resource demand amount of the corresponding pod and the remaining allocatable resource amount of each task processing node may specifically include: constructing a resource demand matrix of the corresponding pod based on the resource demand amount of the corresponding pod in the at least two unit time periods, the resource demand matrix being configured to represent a resource amount of at least one resource type of the corresponding pod in each unit time period; constructing a remaining allocatable resource matrix of the corresponding task processing node based on the remaining allocatable resource amount of each task processing node in the at least two unit time periods, the remaining allocatable resource matrix being configured to represent a remaining allocatable resource amount of at least one resource type of the corresponding task processing node in each unit time period; determining at least one similarity indicator between each task processing node and the corresponding pod based on the resource demand matrix of the corresponding pod and the remaining allocatable resource matrix of each task processing node; and determining the resource matching degree between each task processing node and the corresponding pod based on the at least one similarity indicator.

Specifically, the resource demand amount of each pod is represented by a resource matrix, a quantity of columns of the resource matrix being equal to a quantity of unit time periods included in the preset time period, and a quantity of rows of the resource matrix being equal to a quantity of types of resources that the corresponding pod needs to occupy for running a data processing task; and For example, the resource demand amount of a pod may be represented by the following resource matrix R, where the resource matrix R is as follows.

$$R = [ \begin{matrix}{c}_{0} & {c}_{1} & … & {c}_{23} \\ {m}_{0} & {m}_{1} & … & {m}_{23} \\ {n}_{0} & {n}_{1} & … & {n}_{23}\end{matrix} ]$$

Each row of data represents a different type of resource, each column of data represents an amount of resources occupied in a different unit time period. The first column of data in the R matrix represents an amount of resources occupied by a corresponding pod for the hour from 0:00 to 1:00, the second column of data represents an amount of resources occupied by the corresponding pod for the hour from 1:00 to 2:00, . . . , and the last column represents an amount of resources occupied by the corresponding pod for the hour from 23:00 to 24:00. For example, the first row represents an amount of GPU resources that the corresponding pod needs to occupy, and co may represent an amount of GPU resources that the to-be-scheduled pod needs to occupy for the hour from 0:00 to 1:00.

A remaining allocatable resource amount of a task processing node may also be represented by a remaining allocatable resource matrix. An example in which the task processing node is a task processing node j is used for description, and a remaining allocatable resource matrix corresponding to the task processing node j is represented by Sⱼ, where Sⱼ is as follows.

$${S}_{j} = [ \begin{matrix}{s}_{j , {c}_{0}} & {s}_{j , {c}_{1}} & … & {s}_{j , {c}_{23}} \\ {s}_{j , {m}_{0}} & {s}_{j , {m}_{1}} & … & {s}_{j , {m}_{23}} \\ {s}_{j , {n}_{0}} & {s}_{j , {n}_{1}} & … & {s}_{j , {n}_{23}}\end{matrix} ]$$

Each column of data in the Sⱼ matrix represents: a remaining allocatable resource amount in each time period from 0:00 to 24:00; and a remaining allocatable resource amount of each type of resource in each row of data. For example, the first row in the foregoing Sⱼ matrix still represents the amount of GPU resources, and specifically represents remaining allocatable resource amounts of the task processing node j at different times. Sⱼ, ml represents a remaining allocatable resource amount corresponding to resources of type m of the task processing node j for the hour from 1:00 to 2:00.

Further, after the resource demand matrix of the corresponding pod and the remaining allocatable matrix corresponding to each task processing node are obtained, at least one similarity indicator between the task processing node and the corresponding pod is determined in at least one manner based on the resource demand matrix and the remaining allocatable resource matrix, and then a resource matching degree between the task processing node and the pod is determined based on the at least one similarity indicator.

Specifically, the at least one manner may include: a Euclidean distance and/or a cosine similarity, that is, determining a Euclidean distance between the task processing node and the to-be-scheduled pod, and/or determining a cosine similarity between the task processing node and the to-be-scheduled pod.

Specifically, a Euclidean distance between a remaining allocatable resource matrix S of the node j and a resource demand matrix R of the corresponding pod is calculated based on the following formula 1.

d(R,Sⱼ)=\sqrt{Σ(R−Sⱼ)²}, formula 1,
where d is the calculated Euclidean distance between the remaining allocatable resource matrix S of the node j and the resource demand matrix R of the pod.

Specifically, when a cosine similarity between the remaining allocatable resource matrix S of the node j and the resource demand matrix R of the pod is calculated, the two matrices are first flattened into vectors before the calculation. Specifically, based on the following formula 2, the cosine similarity between the remaining allocatable resource matrix S of the node j and the resource demand matrix R of the pod is calculated.

$$f ( R , {S}_{j} ) = \frac{flatten ( W \cdot R ) \cdot flatten ( W \cdot {S}_{j} )}{‖ flatten ( W \cdot R ) ‖ ‖ flatten ( W \cdot {S}_{j} ) ‖} , \qquad formula 2$$

$$where$$

$$flatten ( W \cdot R ) = flatten ( [ \begin{matrix}2 \cdot {c}_{0} & 2 \cdot {c}_{1} & … & 2 \cdot {c}_{23} \\ {m}_{0} & {m}_{1} & … & {m}_{23} \\ {n}_{0} & {n}_{1} & … & {n}_{23}\end{matrix} ] )$$

$$flatten ( W \cdot {S}_{j} ) = flatten ( [ \begin{matrix}2 \cdot {S}_{j , {c}_{0}} & 2 \cdot {S}_{j , {c}_{1}} & … & 2 {S}_{j , {c}_{23}} \\ {S}_{j , {m}_{0}} & {S}_{j , {m}_{1}} & … & {S}_{j , {m}_{23}} \\ {S}_{j , {n}_{0}} & {S}_{j , {n}_{1}} & … & {S}_{j , {n}_{23}}\end{matrix} ] ) ;$$

$$W = [ \begin{matrix}2 & 0 & 0 \\ 0 & 1 & 0 \\ 0 & 0 & 1\end{matrix} ] ,$$

where the W matrix is user-defined according to the importance of resources. In some embodiments, W is merely a possible implementation, and is not intended to be limiting. An example in which resource types includes CPU resources, MEM resources, and network resources is used. A weight of the CPU resources is 2, a weight of the MEM resources is 1, and a weight of the network resources is 1, that is, cpu weight=2, mem weight=1, and network weight=1.

Further, after the Euclidean distance between the remaining allocatable resource matrix S of the node j and the resource demand matrix R of the pod and the cosine similarity between the remaining allocatable resource matrix S of the node j and the resource demand matrix R of the pod are obtained, a score of the node j is calculated based on the following formula 3, to represent a resource matching degree between the task processing node j and the pod.

$${score}_{j} = f + \frac{1}{1 + d} , \qquad formula 3$$

where f represents the cosine similarity between the remaining allocatable resource matrix S of the node j and the resource demand matrix R of the pod; d is the calculated Euclidean distance between the remaining allocatable resource matrix S of the node j and the resource demand matrix R of the pod; and the scoreⱼ represents a score of the node j.

Further, scores between each task processing node and the corresponding pod may be obtained in the foregoing manner.

Further, scores between each task processing node and the corresponding pod are determined, and the node with the highest score is selected as the node to which the corresponding pod is finally bound. Specifically, as shown in FIG. 3, the enhanced scheduler component selects the node with the highest score as the node to which the corresponding pod is finally bound.

Further, a bind interface is invoked to submit the corresponding pod and the node finally bound to the pod to an application interface server (API Server), to complete the scheduling process.

In some embodiments, the resource demand amount of a pod is predicted based on historical resource usage of the pod. When the target node associated with a pod is determined, if the predicted resource demand amount of the pod is not obtained, a preset resource amount of the pod is obtained. The preset resource amount includes quantities of types of resources. The preset resource amount is determined as a resource demand amount of the pod within the preset time period.

A preset resource amount of the pod is represented by a matrix, and each column of data is a resource amount corresponding to each preset type of resource of the data processing task.

Further, after the preset resource amount of the pod is used as the resource demand amount of the pod within the preset time period, for details of the manner for determining the target node corresponding to the pod based on the resource demand amount of the pod within the preset time period, refer to the foregoing embodiments, and details are not described herein again.

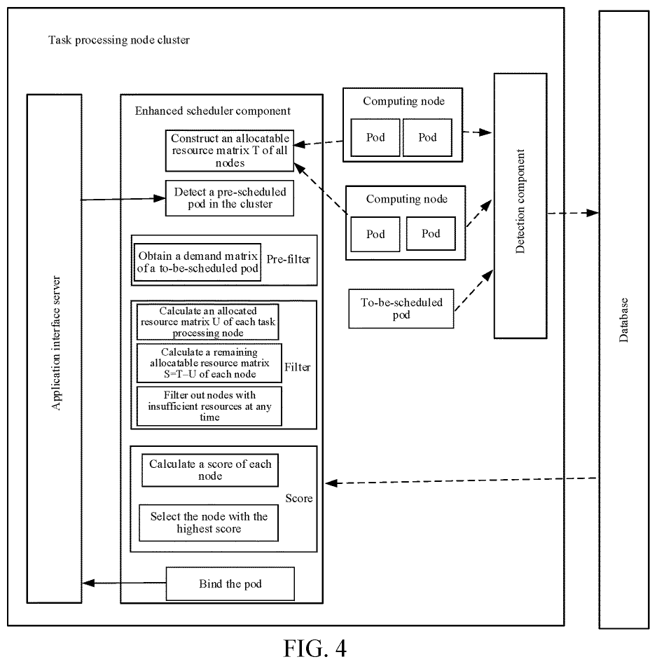

The task processing method according to some embodiments is described by using a specific example. In this example, a Kubernetes cluster is used as an example for description. The Kubernetes cluster includes a plurality of task processing nodes, specifically as shown in the following embodiment and shown in FIG. 4.
Operation 1: Deploy an enhanced scheduler component in the form of a pod in the Kubernetes cluster.
Operation 2: The enhanced scheduler component constructs an allocatable resource matrix T of all nodes in the cluster. Using a node j as an example, the matrix Tⱼ is as follows.

$${T}_{j} = [ \begin{matrix}{t}_{j , {c}_{0}} & {t}_{j , {c}_{1}} & … & {t}_{j , {c}_{23}} \\ {t}_{j , {m}_{0}} & {t}_{j , {m}_{1}} & … & {t}_{j , {m}_{23}} \\ {t}_{j , {n}_{0}} & {t}_{j , {n}_{1}} & … & {t}_{j , {n}_{23}}\end{matrix} ]$$

In the matrix, each row is a resource dimension, and each column is a resource specification at each hour. Because a node specification is unchanged, values in each row are identical.
Operation 3: The enhanced scheduler component detects, from an API Server in the Kubernetes cluster, a creation event of a pod object of a specified enhanced scheduler without a nodename.
Operation 4. The enhanced scheduler component performs scheduling of the pod after detecting the event of the related pod.
(1) Prefilter stage: Obtain a demand matrix R of a pre-scheduled pod from a database. Each row in the matrix is a resource dimension and represents different types of resources. Each column is a resource demand amount for an hour and represents an amount of resources that need to be occupied within the hour,

$$R = [ \begin{matrix}{c}_{0} & {c}_{1} & … & {c}_{23} \\ {m}_{0} & {m}_{1} & … & {m}_{23} \\ {n}_{0} & {n}_{1} & … & {n}_{23}\end{matrix} ]$$

Obtaining a resource demand matrix R of a pre-scheduled pod refers to obtaining a demand matrix of pods in a workload to which the pod belongs. If the demand matrix of the pods in the workload can be successfully obtained, the process proceeds to the next stage. If the demand matrix of the pods in the same workload cannot be found, a resource demand in each column is initialized to be a resource specification declared by the pod.
(2) Filter stage:
\textcircled{1} Calculate an allocated resource matrix U of a node J. Specifically, a manner for calculating the allocated resource matrix U of the node J includes: obtaining k pods of the current node J, the allocated resource matrix U of the node J being a sum of k R matrices. Using the node j as an example, the Uⱼ matrix is as follows.

$${U}_{j} = {\sum }_{k = 1}^{K} {R}_{k}$$

If a value of Rₖ cannot be obtained, Rₖ needs to be initialized to be a resource demand declared by the pod, and each column of the resource demand is initialized to be a resource specification declared by the pod.
\textcircled{2} Calculate a remaining allocatable resource matrix S of each node. Using the node j as an example, a remaining allocatable resource matrix Sⱼ of the node j is calculated by using the following formula,
where

$${S}_{j} = [ \begin{matrix}{s}_{j , {c}_{0}} & {s}_{j , {c}_{1}} & … & {s}_{j , {c}_{23}} \\ {s}_{j , {m}_{0}} & {s}_{j , {m}_{1}} & … & {s}_{j , {m}_{23}} \\ {s}_{j , {n}_{0}} & {s}_{j , {n}_{1}} & … & {s}_{j , {n}_{23}}\end{matrix} ]$$

\textcircled{3} Filter out nodes with insufficient resources at any time. That is, the nodes obtained after filtering meets the following conditions.

∀i∈{0, . . . , 23}, and ∀resource dimension d:r_{d,i}≤S_{j,d}_{ᵢ}:
(3) Score stage:

If a quantity of nodes after filtering is less than two, the Score stage is skipped; and if the quantity of nodes after filtering is not less than two, the Score stage may be executed. In some embodiments, for each node, a score of each node is calculated.

Specifically, using the node j as an example, a manner for calculating the score of the node j is described, including:
calculating a Euclidean distance between the remaining allocatable resource matrix S of the node j and the resource demand matrix R of the pod, specifically by using the following formula,

d(R,Sⱼ)=\sqrt{(R−Sⱼ)²}
where d (R, Sⱼ) represents the Euclidean distance between the remaining allocatable resource matrix S of the node j and the resource demand matrix R of the pod.

When the Euclidean distance between the remaining allocatable resource matrix S of the node j and the resource demand matrix R of the pod is calculated, Sⱼ and R need to be flattened into vectors before the calculation.

A cosine similarity between the remaining allocatable resource matrix S of the node j and the resource demand matrix R of the pod may be specifically calculated by using the following formula,

$$f ( R , {S}_{j} ) = \frac{flatten ( W \cdot R ) \cdot flatten ( W \cdot {S}_{j} )}{‖ flatten ( W \cdot R ) ‖ ‖ flatten ( W \cdot {S}_{j} ) ‖}$$

$$where flatten ( W \cdot R ) = flatten ( [ \begin{matrix}2 \cdot {c}_{0} & 2 \cdot {c}_{1} & … & 2 \cdot {c}_{23} \\ {m}_{0} & {m}_{1} & … & {m}_{23} \\ {n}_{0} & {n}_{1} & … & {n}_{23}\end{matrix} ] ) ;$$

$$flatten ( W \cdot {S}_{j} ) = flatten ( [ \begin{matrix}2 \cdot {S}_{j , {c}_{0}} & 2 \cdot {S}_{j , {c}_{1}} & … & 2 {S}_{j , {c}_{23}} \\ {S}_{j , {m}_{0}} & {S}_{j , {m}_{1}} & … & {S}_{j , {m}_{23}} \\ {S}_{j , {n}_{0}} & {S}_{j , {n}_{1}} & … & {S}_{j , {m}_{23}}\end{matrix} ] ) ; and$$

$$W = [ \begin{matrix}2 & 0 & 0 \\ 0 & 1 & 0 \\ 0 & 0 & 1\end{matrix} ] ,$$

The W matrix is user-defined according to the importance of resources. In some embodiments, W is merely a possible implementation, and is not intended to be limiting. An example in which resource types include CPU resources, MEM resources, and network resources is used. A weight of the CPU resources is 2, a weight of the MEM resources is 1, and a weight of the network resources is 1, that is, cpu weight=2, mem weight=1, and network weight=1.

When the cosine similarity between the remaining allocatable resource matrix Sⱼ of the node j and the resource demand matrix R of a pre-scheduled pod is calculated, Sⱼ and R need to be flattened into vectors before the calculation.

A final score of the node j is calculated based on the Euclidean distance between the remaining allocatable resource matrix S of node j and the resource demand matrix R of the pod and the cosine similarity between the remaining allocable resource matrix S of the node j and the resource demand matrix R of the pod, and through the following formula,

$${score}_{j} = f + \frac{1}{1 + d}$$

where f is the cosine similarity between the remaining allocatable resource matrix S of the node j and the resource demand matrix R of the pod shown above, d is the Euclidean distance between the remaining allocatable resource matrix S of the node j and the resource demand matrix R of the pod shown above, and scoreⱼ is the final score of the node j.

Further, in the Score stage, the scores corresponding to the nodes are calculated, and the node with the highest score is selected as the node to which the pod is finally bound.

Finally, a bind interface is invoked to submit the pod and a final scheduling result to an application interface server (API Server), to complete the scheduling process.

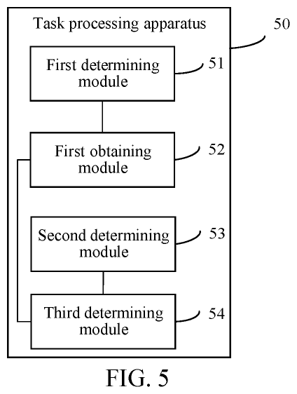

Based on the same principle as the task processing method provided in some embodiments, one or more embodiments further provides a task processing apparatus. As shown in FIG. 5, the apparatus 50 may include a first determining module 51, a first obtaining module 52, a second determining module 53, and a third determining module 54, where
the first determining module 51 is configured to determine at least one pod, each pod being configured to process at least one data processing task;
the first obtaining module 52 is configured to obtain a resource demand amount of each pod within a preset time period;
the second determining module 53 is configured to determine a remaining allocatable resource amount of each task processing node in a task processing node cluster within the preset time period, the cluster including at least two task processing nodes; and
the third determining module 54 is configured to determine, based on the resource demand amount of each pod and the remaining allocatable resource amount of each task processing node, a target node associated with the corresponding pod from the at least two task processing nodes, to run the corresponding pod in the target node.

Compared with the related art, in some embodiments, for a to-be-scheduled pod, when a task processing node for scheduling the pod is determined from a plurality of task processing nodes in a task processing node cluster, a target task processing node is determined based on a resource demand amount of the to-be-scheduled pod within a preset time period and a relationship among remaining allocatable resource amounts corresponding to the task processing nodes within the preset time period, to schedule the pod to execute a corresponding task, thereby improving accuracy of node allocation for the to-be-scheduled pod, and further minimizing the occurrence of load imbalance. In addition, because the resource demand amount of the to-be-scheduled pod within the preset time period is obtained based on historical resource usage of the pod, accuracy of the resource demand amount of the to-be-scheduled pod within the preset time period is higher, so that accuracy of the node allocation for the to-be-scheduled pod can be further improved, thereby further improving load balance.

The apparatus in some embodiments may perform the method provided in one or more embodiments, and their implementation principles are similar. The actions performed by the modules in the apparatus in some embodiments corresponds to the operations in the method in one or more embodiments. For a detailed description of functions of the modules of the apparatus, refer to the description of the corresponding method shown above, and details are not described herein again.

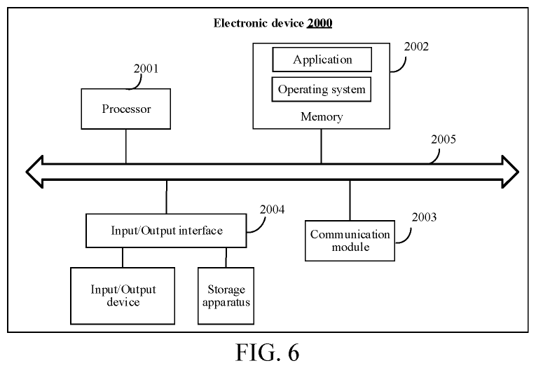

FIG. 6 is a schematic structural diagram of an electronic device applicable to one or more embodiments. As shown in FIG. 6, for example, the electronic device may be a server or a user terminal, and the electronic device may be configured to implement the method provided in some embodiments.

As shown in FIG. 6, the electronic device 2000 may mainly include components such as at least one processor 2001 (one is shown in FIG. 6), a memory 2002, a communication module 2003, and an input/output interface 2004. In an embodiment, connection and communication may be implemented between the components through a bus 2005. The structure of the electronic device 2000 shown in FIG. 6 is merely exemplary, and does not constitute a limitation to the electronic device to which the method provided in some embodiments is applicable.

The memory 2002 may be configured to store an operating system, an application, and the like. The application may include a computer program that implements the method shown in the embodiments of the present disclosure when invoked by the processor 2001, or may include a program configured for implementing other functions or services. The memory 2002 may be a read-only memory (ROM) or a static storage device of another type that can store static information and instructions, a random access memory (RAM) or a dynamic storage device of another type that can store information and a computer program, or an electrically erasable programmable read-only memory (EEPROM), a compact disc read-only memory (CD-ROM) or other optical disk storage, optical disc storage (including a compact disc, a laser disc, an optical disc, a digital versatile disc, a Blue-ray disc, and the like), a disk storage medium or another magnetic storage device, or any other medium that can be configured to carry or store expected program code in instructions or data structure form and that can be accessed by a computer, but is not limited thereto.

The processor 2001 is connected to the memory 2002 by using the bus 2005, and implements corresponding functions by calling the application stored in the memory 2002. The processor 2001 may be a central processing unit (CPU), a general purpose processor, a digital signal processor (DSP), an application-specific integrated circuit (ASIC), a field programmable gate array (FPGA), or another programmable logic device, a transistor logic device, a hardware component, or any combination thereof. The processor 2001 may implement or execute any exemplary logic block, module, and circuit described in the content disclosed by the present disclosure. The processor 2001 may alternatively be a combination that implements computing functions, for example, including a combination of one or more microprocessors or a combination of a DSP and a microprocessor.

The electronic device 2000 may be connected to a network through the communication module 2003 (which may include, but is not limited to, a component such as a network interface), to communicate with another device (such as a user terminal or a server) through the network, to implement data exchange, for example, transmit data to or receive data from another device. The communication module 2003 may include a wired network interface and/or a wireless network interface. In other words, the communication module may include at least one of a wired communication module or a wireless communication module.

The electronic device 2000 may be connected to a required input/output device such as a keyboard or a display device through the input/output interface 2004. The electronic device 2000 may have a display device, or may be externally connected to another display device through the interface 2004. In an embodiment, the interface 2004 may also be used to connect to a storage apparatus, such as a hard disk, to store data in the electronic device 2000 into the storage apparatus, or to read data in the storage apparatus, and further to store data in the storage apparatus into the memory 2002. The input/output interface 2004 may be a wired interface or a wireless interface. According to different actual application scenarios, a device connected to the input/output interface 2004 may be a component of the electronic device 2000, or may be an external device connected to the electronic device 2000 as required.

The bus 2005 configured to connect the components may include a channel, to transmit information between the foregoing components. The bus 2005 may be a peripheral component interconnect (PCI) bus, an extended industry standard architecture (EISA) bus, or the like. According to different functions, the bus 2005 may be classified into an address bus, a data bus, a control bus, and the like.

In some embodiments, the memory 2002 may be configured to store a computer program for performing the solutions of the disclosure, and run by the processor 2001. When the processor 2001 runs the computer program, the actions of the method or apparatus provided in some embodiments are implemented.

Based on the same principle as the method provided in some embodiment, one or more embodiments provides a computer-readable storage medium, having a computer program stored therein. The computer program, when executed by a processor, may implement the corresponding content of the foregoing method embodiments.

One or more embodiments further provides a computer program product, including a computer program. The computer program, when executed by a processor, may implement the corresponding content of the foregoing method embodiments.

The terms “first”, “second”, “third”, “fourth”, “1”, “2”, and the like (if exists) in this specification and the claims of the disclosure and the foregoing accompanying drawings are configured for distinguishing similar objects, and do not need to be configured for describing a particular sequence or order. Data used in this way may be interchanged in a proper circumstance so that the various embodiments described herein can be implemented in an order other than that illustrated or described.

In some embodiments, the term “module” or “unit” refers to a computer program having predetermined functions or a part of a computer program, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an entire module or unit including functions of the module or unit.

Although the flowcharts in some embodiments indicate various operations and steps by using arrows, the order in which these operations are performed is not limited to the order indicated by the arrows. Unless explicitly described in this specification, in some implementation scenarios of one or more embodiments, implementation operations in the flowcharts may be performed in another order according to requirements. In addition, some or all of the operations in the flowcharts may include a plurality of sub-operations or a plurality of stages based on actual implementation scenarios. Some or all of these sub-operations or stages may be performed at the same time, and each of these sub-operations or stages may be separately performed at different times. In scenarios with different execution times, the execution order of these sub-operations or stages may be flexibly configured according to requirements. This is not limited herein.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A task processing method, performed by an electronic device, comprising:
determining at least one pod, each pod of the at least one pod being configured to process at least one data processing task;
obtaining a resource demand amount of each pod within a preset time period;
determining a remaining allocatable resource amount of each task processing node in a task processing node cluster within the preset time period, the task processing node cluster comprising at least two task processing nodes; and
determining, based on the resource demand amount of each pod and the remaining allocatable resource amount of each task processing node, a target node associated with a corresponding pod from the at least two task processing nodes to run the corresponding pod in the target node.

2. The task processing method according to claim 1, wherein the determining, based on the resource demand amount of each pod and the remaining allocatable resource amount of each task processing node, the target node associated with the corresponding pod from the at least two task processing nodes, to run the corresponding pod in the target node comprises:
selecting at least one candidate node meeting the resource demand amount of the corresponding pod from the at least two task processing nodes based on the remaining allocatable resource amount of each task processing node; and
determining the target node associated with the corresponding pod from the at least one candidate node based on the resource demand amount of the corresponding pod and a remaining allocatable resource amount of each of the at least one candidate node.

3. The task processing method according to claim 2, wherein the preset time period comprises at least two unit time periods, each unit time period having a duration of a preset time unit, the resource demand amount of each pod comprises a resource demand amount of the corresponding pod in each unit time period within the preset time period, and the remaining allocatable resource amount of each task processing node comprises a remaining allocatable resource amount of the corresponding task processing node in each unit time period within the preset time period, and
wherein selecting the at least one candidate node meeting the resource demand amount of the corresponding pod from the at least two task processing nodes based on the remaining allocatable resource amount of each task processing node comprises:
selecting at least one candidate node from the at least two task processing nodes based on the remaining allocatable resource amount of each task processing node in each unit time period and the resource demand amount of the corresponding pod in each unit time period, for each unit time period, the remaining allocatable resource amount of each candidate node in the unit time period being greater than the resource demand amount of the corresponding pod in the corresponding unit time period.

4. The task processing method according to claim 1, wherein the determining based on the resource demand amount of each pod and the remaining allocatable resource amount of each task processing node, a target node associated with the corresponding pod from the at least two task processing nodes, to run the corresponding pod in the target node comprises:
determining a resource matching degree between each task processing node and the corresponding pod based on the resource demand amount of the corresponding pod and the remaining allocatable resource amount of each task processing node; and
determining the target node associated with the corresponding pod from the at least two task processing nodes based on the resource matching degree.

5. The task processing method according to claim 4, wherein the preset time period comprises at least two unit time periods, each unit time period having a duration of a preset time unit, the resource demand amount of each pod comprises a resource demand amount of the corresponding pod in each unit time period within the preset time period, and the remaining allocatable resource amount of each task processing node comprises a remaining allocatable resource amount of the corresponding task processing node in each unit time period within the preset time period; and
wherein determining the resource matching degree between each task processing node and the corresponding pod based on the resource demand amount of the corresponding pod and remaining allocatable resources of each task processing node comprises:
constructing a resource demand matrix of the corresponding pod based on the resource demand amount of the corresponding pod in the at least two unit time periods, the resource demand matrix being configured to represent a resource amount of at least one resource type of the corresponding pod in each unit time period;
constructing a remaining allocatable resource matrix of the corresponding task processing node based on the remaining allocatable resource amount of each task processing node in the at least two unit time periods, the remaining allocatable resource matrix being configured to represent a remaining allocatable resource amount of at least one resource type of the corresponding task processing node in each unit time period;
determining at least one similarity indicator between each task processing node and the corresponding pod based on the resource demand matrix of the corresponding pod and the remaining allocatable resource matrix of each task processing node; and
determining the resource matching degree between each task processing node and the corresponding pod based on the at least one similarity indicator.

6. The task processing method according to claim 1, wherein determining the remaining allocatable resource amount of each task processing node in the task processing node cluster within the preset time period comprises:
obtaining a resource demand amount of each pod running on each task processing node within the preset time period;
determining an allocated resource amount of the corresponding task processing node based on the resource demand amount of each pod running on each task processing node within the preset time period;
obtaining an initial allocatable resource amount of each task processing node, the initial allocatable resource amount of each task processing node being an allocatable resource amount of the corresponding task processing node when no pod is running; and
determining the remaining allocatable resource of each task processing node within the preset time period based on the initial allocatable resource amount of each task processing node and the allocated resource amount of each task processing node.

7. The task processing method according to claim 1, further comprising:
obtaining historical resource usage of each pod, the historical resource usage of each pod being resource usage of the corresponding pod in a runtime period;
predicting the resource demand amount of each pod based on the historical resource usage of each pod; and
storing the resource demand amount of each pod.

8. The task processing method according to claim 1, wherein the resource demand amount of each pod is represented by a resource matrix, a quantity of columns of the resource matrix being equal to a quantity of unit time periods comprised in the preset time period, and a quantity of rows of the resource matrix being equal to a quantity of types of resources that the corresponding pod needs to occupy for running a data processing task; and
wherein the task processing method further comprises:
obtaining, if the resource demand amount of a pod is not obtained, a preset resource amount of the pod, the preset resource amount comprising quantities of types of resources; and
determining the preset resource amount as the resource demand amount of the pod within the preset time period.

9. A task processing apparatus, comprising:
at least one memory configured to store program code; and
at least one processor configured to read the program code and operate as instructed by the program code, the program code comprising:
first determining code configured to cause at least one of the at least one processor to determine at least one pod, each pod of the at least one pod being configured to process at least one data processing task;
first obtaining code configured to cause at least one of the at least one processor to obtain a resource demand amount of each pod within a preset time period;
second determining code configured to cause at least one of the at least one processor to determine a remaining allocatable resource amount of each task processing node in a task processing node cluster within the preset time period, the task processing node cluster comprising at least two task processing nodes; and
third determining code configured to cause at least one of the at least one processor to determine, based on the resource demand amount of each pod and the remaining allocatable resource amount of each task processing node, a target node associated with a corresponding pod from the at least two task processing nodes, to run the corresponding pod in the target node.

10. The task processing apparatus according to claim 9, wherein the third determining code is further configured to cause at least one of the at least one processor to:
select at least one candidate node meeting the resource demand amount of the corresponding pod from the at least two task processing nodes based on the remaining allocatable resource amount of each task processing node; and
determine the target node associated with the corresponding pod from the at least one candidate node based on the resource demand amount of the corresponding pod and a remaining allocatable resource amount of each of the at least one candidate node.

11. The task processing apparatus according to claim 10, wherein the preset time period comprises at least two unit time periods, each unit time period having a duration of a preset time unit, the resource demand amount of each pod comprises a resource demand amount of the corresponding pod in each unit time period within the preset time period, and the remaining allocatable resource amount of each task processing node comprises a remaining allocatable resource amount of the corresponding task processing node in each unit time period within the preset time period, and
wherein the third determining code is further configured to cause at least one of the at least one processor to:
select at least one candidate node from the at least two task processing nodes based on the remaining allocatable resource amount of each task processing node in each unit time period and the resource demand amount of the corresponding pod in each unit time period, for each unit time period, the remaining allocatable resource amount of each candidate node in the unit time period being greater than the resource demand amount of the corresponding pod in the corresponding unit time period.

12. The task processing apparatus according to claim 9, wherein the third determining code is further configured to cause at least one of the at least one processor to:
determine a resource matching degree between each task processing node and the corresponding pod based on the resource demand amount of the corresponding pod and the remaining allocatable resource amount of each task processing node; and
determine the target node associated with the corresponding pod from the at least two task processing nodes based on the resource matching degree.

13. The task processing apparatus according to claim 12, wherein the preset time period comprises at least two unit time periods, each unit time period having a duration of a preset time unit, the resource demand amount of each pod comprises a resource demand amount of the corresponding pod in each unit time period within the preset time period, and the remaining allocatable resource amount of each task processing node comprises a remaining allocatable resource amount of the corresponding task processing node in each unit time period within the preset time period; and
wherein the third determining code is further configured to cause at least one of the at least one processor to:
construct a resource demand matrix of the corresponding pod based on the resource demand amount of the corresponding pod in the at least two unit time periods, the resource demand matrix being configured to represent a resource amount of at least one resource type of the corresponding pod in each unit time period;
construct a remaining allocatable resource matrix of the corresponding task processing node based on the remaining allocatable resource amount of each task processing node in the at least two unit time periods, the remaining allocatable resource matrix being configured to represent a remaining allocatable resource amount of at least one resource type of the corresponding task processing node in each unit time period;
determine at least one similarity indicator between each task processing node and the corresponding pod based on the resource demand matrix of the corresponding pod and the remaining allocatable resource matrix of each task processing node; and
determine the resource matching degree between each task processing node and the corresponding pod based on the at least one similarity indicator.

14. The task processing apparatus according to claim 1, wherein the second determining code is further configured to cause at least one of the at least one processor to:
obtain a resource demand amount of each pod running on each task processing node within the preset time period;
determine an allocated resource amount of the corresponding task processing node based on the resource demand amount of each pod running on each task processing node within the preset time period;
obtain an initial allocatable resource amount of each task processing node, the initial allocatable resource amount of each task processing node being an allocatable resource amount of the corresponding task processing node when no pod is running; and
determine the remaining allocatable resource of each task processing node within the preset time period based on the initial allocatable resource amount of each task processing node and the allocated resource amount of each task processing node.

15. The task processing apparatus according to claim 1, wherein the first obtaining code is further configured to cause at least one of the at least one processor to:
obtain historical resource usage of each pod, the historical resource usage of each pod being resource usage of the corresponding pod in a runtime period;
predict the resource demand amount of each pod based on the historical resource usage of each pod; and
store the resource demand amount of each pod.

16. The task processing apparatus according to claim 1, wherein the resource demand amount of each pod is represented by a resource matrix, a quantity of columns of the resource matrix being equal to a quantity of unit time periods comprised in the preset time period, and a quantity of rows of the resource matrix being equal to a quantity of types of resources that the corresponding pod needs to occupy for running a data processing task; and
wherein the first obtaining code is further configured to cause at least one of the at least one processor to:
obtain, if the resource demand amount of a pod is not obtained, a preset resource amount of the pod, the preset resource amount comprising quantities of types of resources; and
determine the preset resource amount as the resource demand amount of the pod within the preset time period.

17. A non-transitory computer-readable storage medium, storing computer code which, when executed by at least one processor, causes the at least one processor to at least:
determine at least one pod, each pod of the at least one pod being configured to process at least one data processing task;
obtain a resource demand amount of each pod within a preset time period;
determine a remaining allocatable resource amount of each task processing node in a task processing node cluster within the preset time period, the task processing node cluster comprising at least two task processing nodes; and
determine, based on the resource demand amount of each pod and the remaining allocatable resource amount of each task processing node, a target node associated with a corresponding pod from the at least two task processing nodes to run the corresponding pod in the target node.

18. The non-transitory computer-readable storage medium according to claim 17, wherein the determine, based on the resource demand amount of each pod and the remaining allocatable resource amount of each task processing node, the target node associated with the corresponding pod from the at least two task processing nodes, to run the corresponding pod in the target node comprises:
selecting at least one candidate node meeting the resource demand amount of the corresponding pod from the at least two task processing nodes based on the remaining allocatable resource amount of each task processing node; and
determining the target node associated with the corresponding pod from the at least one candidate node based on the resource demand amount of the corresponding pod and a remaining allocatable resource amount of each of the at least one candidate node.

19. The non-transitory computer readable storage medium according to claim 18, wherein the preset time period comprises at least two unit time periods, each unit time period having a duration of a preset time unit, the resource demand amount of each pod comprises a resource demand amount of the corresponding pod in each unit time period within the preset time period, and the remaining allocatable resource amount of each task processing node comprises a remaining allocatable resource amount of the corresponding task processing node in each unit time period within the preset time period, and
wherein the select the at least one candidate node meeting the resource demand amount of the corresponding pod from the at least two task processing nodes based on the remaining allocatable resource amount of each task processing node comprises:
selecting at least one candidate node from the at least two task processing nodes based on the remaining allocatable resource amount of each task processing node in each unit time period and the resource demand amount of the corresponding pod in each unit time period, for each unit time period, the remaining allocatable resource amount of each candidate node in the unit time period being greater than the resource demand amount of the corresponding pod in the corresponding unit time period.

20. The non-transitory computer-readable storage medium according to claim 17, wherein the determine based on the resource demand amount of each pod and the remaining allocatable resource amount of each task processing node, a target node associated with the corresponding pod from the at least two task processing nodes, to run the corresponding pod in the target node comprises:
determining a resource matching degree between each task processing node and the corresponding pod based on the resource demand amount of the corresponding pod and the remaining allocatable resource amount of each task processing node; and
determining the target node associated with the corresponding pod from the at least two task processing nodes based on the resource matching degree.
